(19) United States
(12) Patent Application Publication
(10) Pub. No.: US 2002/0074880 A1
(43) Pub. Date: Jun. 20, 2002

(54) Hydrodynamic bearing motor

(75) Inventor: Choi Tae Young, Yongin-Shi (KR)

Correspondence Address: DARBY & DARBY P.C., 805 Third Avenue, New York, NY, 10022, US

(73) Assignee: SAMSUNG ELECTRO-MECHANICS CO., LTD., Kyungki-Do (KR)

(21) Appl. No.: 09/858,696

(22) Filed: May 16, 2001

(30) Foreign Application Priority Data
Aug. 25, 2000 (KR) 2000-49715

(51) Int. Cl. H02K 7/08

(52) U.S. Cl. 310/90

(57) ABSTRACT

The invention discloses a hydrodynamic bearing motor. The hydrodynamic bearing motor comprises: a housing integrated with a sleeve which has a vertically penetrated axial hole and is extended upward in a tubular shape in a central portion of the housing; cores coupled to an outer peripheral surface of the sleeve; a shaft for being rotatably inserted into the axial hole of the sleeve and having a flat thrust integrally formed in an lower end thereof; a hub integrally coupled to an upper end of the shaft and having a downwardly extended end wherein a magnet having at least two poles is attached in an inner peripheral surface of the downwardly extended end for interacting with the cores to generate an electromagnetic force; and a cover plate for blocking the lower end of the axial hole of the sleeve wherein the shaft is inserted. The assembly workability, processability and productivity can be enhanced and the NRRO and RRO features of the motor can be improved due to the structural stiffness and endurance so that reliability on extension of life time and performance can be enhanced as a very useful effect.

### BACKGROUND OF THE INVENTION

1. Field of the Invention

The present invention relates to a motor loaded in a small sized precision device, and more particularly, to a hydrodynamic bearing motor enhanced in assembly precision so as to improve irregular vibration properties.

2. Description of the Prior Art

In general, a motor used in the precision device such as a hard disk is required to have such a property that can be precisely controlled and a high-speed driving force as well.

As an example, as personal computers have developed remarkably, recording density of the hard disk is increasing in a great amount as well. Also, even though the rotative velocity has been enhanced up to more than 10,000 rpm from at most 7,200 rpm to increase data access speed, the requirement for stability and calmness is being raised also.

A ball bearing has reached the limitation of its performance to satisfy these requirements. In order to solve this problem, recently a hydrodynamic bearing excellent in impact resistance with little vibration and noise is increasingly adopted as supporting means for a shaft instead of a conventional metal bearing or the ball bearing.

Such a hydrodynamic bearing motor is mainly classified into a shaft-rotating type and a shaft-fixed type according to rotation of the shaft, and uses oil as supporting means for allowing a rotor to smoothly rotate in a high-speed.

Meanwhile, such oil is filled between the shaft and a sleeve wrapping the shaft to minimize a friction force due to the direct contact between the shaft and the sleeve and cause the shaft to be always located in the center of the sleeve.

FIG. 1 and FIG. 2 show an example of the shaft-rotating motor with the shaft being rotated in the conventional hydrodynamic bearing, in which components of the motor comprise a fixed member including a housing 100, a sleeve 110 and cores 120, and a rotary member including a shaft 130, a hub 140 and a magnet 150.

The sleeve 110 is adapted to have a central portion being vertically penetrated to rotatably receive the shaft 130, and an inside diameter surface with grooves 111 to generate a hydrodynamic pressure in the radial direction of the shaft 130.

In particular, the sleeve 110 has an inside diameter portion configured so that a flat annular thrust 160 can be rotatably coupled with the shaft 130 at the lower end of the shaft 130, and an outer diameter portion having the cores 120 wound with coils are fixedly mounted to the outer peripheral end thereof.

Here, the thrust 160 has hydrodynamic pressure generating grooves 161 in the upper and lower surfaces so that the hydrodynamic pressure can be generated in the axial direction.

Meanwhile, the lower end of the sleeve 110 is blocked from the outside as the inside radius portion is shielded by a cover plate 170, and the cover plate 170 is rotatably contacted with the thrust 160 at the upper side.

The upper end of the shaft 130 which is rotatably inserted into the inside radius portion of the sleeve 110 is integrally coupled with the hub 140, which is shaped as a cap opened downward and has the inside radius surface of the extended end where magnets 150 are mounted as opposed to the outside radius surface of the cores 120.

In this configuration, the inside radius surface of the sleeve 110 together with the shaft 130 and the thrust 160 form slight oil gaps G therebetween, where oil is filled with a certain degree of viscosity.

Such oil in the oil gaps G is concentrated into the dynamic pressure generating grooves 111 of the sleeve 110 and the dynamic pressure generating grooves 161 of the thrust 160 to constantly maintain the oil gaps G in the uniform status so that the shaft 130 can be stably operated.

In the shaft-rotating hydrodynamic bearing motor having the foregoing configuration, when the cores 120 are externally powered, the hub 140 having the magnets 150 fixed thereto is rotated due to a mutual electromagnetic force between the cores 120 and the magnets 150 causing the shaft 130 coupled to the hub 140 to be rotated simultaneously.

In operating such a motor, the shaft 130 inserted into the inside radius portion of the sleeve 110 can be smoothly rotated while maintaining noncontact state with the inside radius surface of the sleeve 110 by the hydrodynamic pressure generated in the grooves 111 formed in the inside radius surface of the sleeve 110 and the outside radius surface of the shaft 130.

In other words, a suitable amount of oil is supplied between the outside radius surface of the shaft 130 and the inside surface of the sleeve 110 to flow along the grooves 111 formed in the inside radius surface of the sleeve 110 as the shaft 130 is rotated so that a high-speed rotation can be smoothly carried out while a rotative load is minimized.

FIG. 3 to FIG. 4 show an example of the shaft-fixed motor with the shaft being fixed in the conventional hydrodynamic bearing, in which components of the motor comprise a fixed member including a housing 100, cores 120 and a shaft 130, and a rotary member including a sleeve 110, a hub 140 and magnets 150.

Such a shaft-fixed hydrodynamic bearing motor comprises the components substantially similar to those of the foregoing shaft-rotating hydrodynamic bearing motor except for the configuration that the sleeve 110 and the hub 140 are integrally coupled and rotated about the shaft 130 fixed to the housing 100, in which an inside radius portion of the sleeve 110 and the shaft 130 form oil gaps G therebetween where oil is filled with a certain degree of viscosity.

In particular, the sleeve 110 is so coupled that a flat annular thrust 160 at the upper end of the shaft 130 can be integrally rotated with the shaft 130, and the lower end of the shaft 130 is integrally axis-fixed to a central portion of the housing 100.

Here, the housing 100 has an end portion around a through-hole for receiving the shaft 130 which is extended upward with a certain height. The extended end portion has the outer peripheral end to which the cores 120 wound with coils are fixedly mounted.

Here, the thrust 160 has hydrodynamic pressure generating grooves 161 in the upper and lower surfaces so that a hydrodynamic pressure can be generated in the axial direction.

Meanwhile, the upper end of the sleeve 110 is blocked from the outside as the inside radius portion is shielded by a cover plate 170, and the cover plate 170 is rotatably contacted with the thrust 160 at the lower side.

The upper outer peripheral surface of the sleeve 110 is fixedly coupled with the hub 140 so that the hub 140 can be rotated integrally therewith, and the hub 140 has the inner peripheral surface to which the magnets are mounted as opposed to outside radius surfaces of the cores 120.

In this configuration, the inside radius surface of the sleeve 110 and the thrust 160 form the oil gaps G therebetween where oil is filled as in the foregoing shaft-rotating motor.

In the shaft-fixed hydrodynamic bearing motor having the foregoing configuration, when the cores 120 are powered, the hub 140 having the magnets 150 fixed thereto is rotated due to a mutual electromagnetic force between the cores 120 and the magnets 150 causing the sleeve 110 coupled with the hub 140 to be rotated about the shaft 110 which is integrally coupled to the housing 100.

Therefore, in the shaft-fixed motor, the sleeve 110 is rotated while maintaining noncontact state with the shaft 130 by the hydrodynamic pressure generated between the dynamic pressure generating grooves formed in the outside radius surface of the shaft 130 and the sleeve 110.

However, the shaft-rotating or shaft fixed hydrodynamic bearing motor configured as above in the prior art has a problem that vibration features are determined according to assembled degrees of the sleeve 110.

In other words, the conventional hydrodynamic bearing motor goes through an interference fitting in which the sleeve 110 is forced into the housing 100 so that the sleeve 110 is deformed by the pressure applied from the housing 100 side to show a poor roundness.

FIG. 5 and FIG. 6 are graphs for showing the roundness and straightness measured about the sleeve in the hydrodynamic bearing motor in the prior art shown in FIG. 1.

Considering the roundness of the sleeve 110 shown in FIG. 5, when the hydrodynamic pressure generating grooves 111 are designed with a depth of 4 μm, it can be seen that a difference is generated between the upper and lower inside radius portions of the sleeve 110 as shown in FIG. 5 to make the shape of the grooves ununiform while the average depth is measured 3.5 μm which fails to reach the designed value of 4 μm.

Meanwhile, considering the straightness of the sleeve 110 shown in FIG. 6, it can be seen that the lower inside radius portion of the sleeve 110, to which an assembling force of the housing 100 or the hub 140 is directly applied, is deformed more heavily than the upper inside radius portion to generate the inside radius difference of 2 μm therebetween.

In other words, the sleeve 110 is forced into the housing 100 in the shaft-rotating motor and the sleeve 110 is forced into the hub 140 in the shaft-fixed motor as described hereinbefore, the inside radius surface of the sleeve 110 generates a certain amount of deviation in the roundness and the straightness due to dimension dispersion or assembly dispersion between each part.

Therefore, there is a disadvantage in the aspect of dispersion management since the vibration features of the motors are determined according to assembled degrees of the sleeve 110 or the deviation from coaxiality thereof.

Also, since it is in inter-part assembly which requires to consider coupling force in machining, there is a restriction in enhancing precision, and in particular, there is a problem that the coaxiality of the sleeve is deviated due to a clearance created from inter-part assembly tolerance so that NRRO(Non-Repeatable Run-Out) and RRO(Repeatable Run-Out) features are increased.

In other words, in the hydrodynamic bearing, if a clearance is narrowed as a rotary body is biased into one direction, a pressure is accordingly generated in a large amount to restore the rotary body into the original position. However, if the degree of distortion or the deviation from coaxiality is increased, the variation of the hydrodynamic pressure is enhanced to increase the vibration features such as NRRO, RRO, etc.

Meanwhile, since the thrust 160 is assembled into the shaft 130 through a hot interference fitting, a high degree of precision is required to machine the inside radius of the thrust 160 while necessarily maintaining the right angle with the shaft 130. There are problems that it is very difficult to machine the thrust 160 itself while a very difficult work is required in managing the right angle with the shaft 130 in assembling the thrust 160.

In particular, the sleeve 110 comprises a material having a thermal expansion coefficient larger than that of an SUS group metal such as blister copper or bronze while the thrust 160 and the shaft 130 employ the SUS group metal so that there is a problem that the oil gaps G show features of being excessively spreaded or heavily varied in a hot temperature due to the difference in the thermal expansion coefficients of the both materials to make the operation of the motor unstable.

Therefore, a vibration is generated according to the assembled degrees between the sleeve 110 and the housing 100 or the sleeve 110 and the hub 140 thereby causing a problem that reliability about a product is weakened in a great amount while performance of the motor is lowered due to the vibration.

### SUMMARY OF THE INVENTION

It is a main object of the present invention to provide a hydrodynamic bearing motor having a sleeve integrally manufactured with a housing in a shaft-rotating motor and with a hub in a shaft-fixed motor so that vibration features due to assembly tolerance can be minimized and easy workability and productivity can be enhanced.

Also, it is another object of the present invention to lower the stiffness decrease and RRO features according to the temperature growth by manufacturing the sleeve with a silicon aluminium which has a thermal expansion coefficient similar to an SUS and integrally machining the housing and the sleeve.

According to an embodiment of the invention to obtain the foregoing objects, it is provided a hydrodynamic bearing motor comprising: a housing integrated with a sleeve which has a vertically penetrated axial hole and is extended upward in a tubular shape in a central portion of the housing; cores coupled to an outer peripheral surface of the sleeve; a shaft for being rotatably inserted into the axial hole of the sleeve and having a flat thrust integrally formed in an lower end therof; a hub integrally coupled to an upper end of the shaft and having a downwardly extended end wherein a magnet having at least two poles is attached in an inner peripheral surface of the downwardly extended end thereof for interacting with the cores to generate an electromagnetic force; and a cover plate for blocking the lower end of the axial hole of the sleeve wherein the shaft is inserted.

It is preferred that the sleeve is formed of a ceramic-alloyed aluminium.

According to another embodiment of the invention to obtain the foregoing objects, it is provided a hydrodynamic bearing motor comprising: a housing having an upwardly extended outer peripheral edge and an axial hole vertically penetrated in a central portion; a hub having a integral sleeve which has a vertically penetrated axial hole and is extended downward in a tubular shape in a central portion of the hub, and a downwardly extended end wherein a magnet having at least two poles is attached in an inner peripheral surface of said downwardly extended end thereof; cores coupled to an outer peripheral surface of an extended portion extended around the axial hole of the housing for generating an electromagnetic force via an interaction with the opposed magnet to rotate the hub; a shaft vertically inserted into the axial hole of the sleeve, the shaft having an upper end integrally formed with a flat thrust and a lower end fixedly coupled to the axial hole of the housing, wherein the hub is rotated about the shaft; and a cover plate for blocking an upper end of the axial hole of the sleeve wherein the shaft is inserted.

It is preferred that the sleeve is formed of a ceramic-alloyed aluminium.

### BRIEF DESCRIPTION OF THE DRAWING

FIG. 1 is a sectional view for showing a shaft-rotating bearing motor in the prior art;

FIG. 2 is a perspective view for showing main parts of FIG. 1;

FIG. 3 is a sectional view for showing a shaft-fixed bearing motor in the prior art;

FIG. 4 is a disassembled perspective view for showing main parts of FIG. 3;

FIG. 5 is a graph for showing a roundness measured about the hydrodynamic bearing motor shown in FIG. 1;

FIG. 6 is a graph for showing a straightness measured about the hydrodynamic bearing motor shown in FIG. 1;

FIG. 7 is a sectional view for showing a shaft-rotating bearing motor according to the invention;

FIG. 8 is a disassembled perspective view of main parts of FIG. 7;

FIG. 9 is a sectional view for showing a shaft-fixed bearing motor according to the invention;

FIG. 10 is a disassembled perspective view of main parts of FIG. 9;

FIG. 11 is a graph for showing a roundness measured about the hydrodynamic bearing motor shown in FIG. 7;

FIG. 12 is a graph for showing a straightness measured about the hydrodynamic bearing motor shown in FIG. 7;

FIG. 13 and FIG. 14 are graphs for showing a result of comparing the hydrodynamic bearing motor of the invention with that of the prior art in load capacity, stiffness and damping;

FIG. 15 and FIG. 16 are graphs for showing a result of comparing the hydrodynamic bearing motor of the invention with that of the prior art in stiffness; and

FIG. 17 and FIG. 18 are graphs for showing a result of comparing the hydrodynamic bearing motor of the invention with that of the prior art in damping.

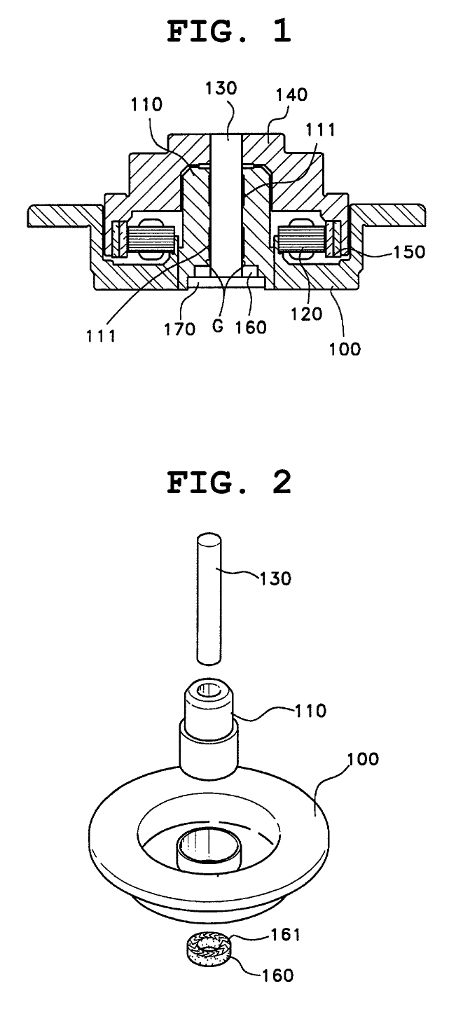

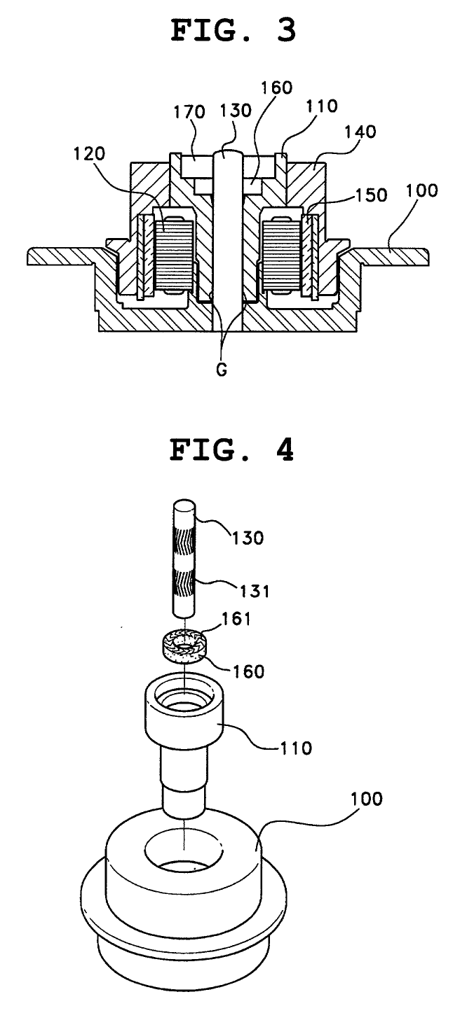

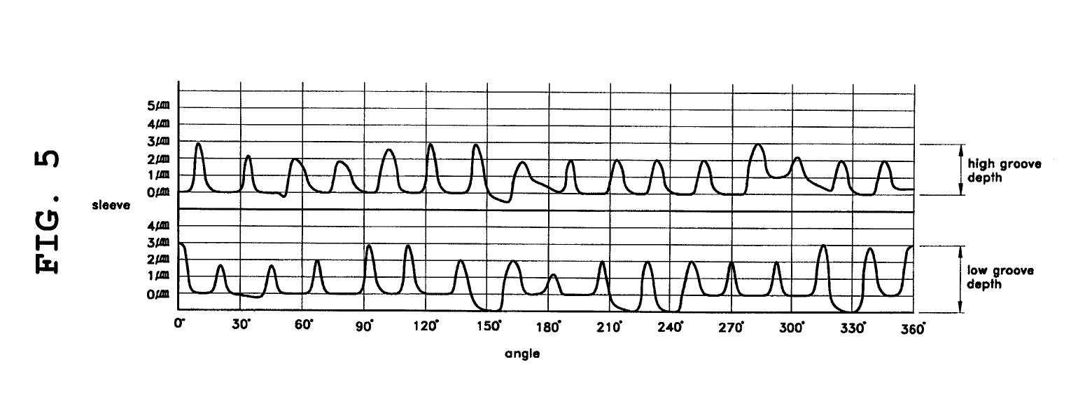

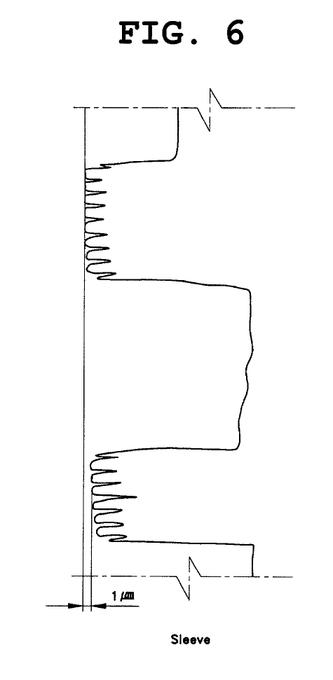

### DESCRIPTION OF THE PREFERRED EMBODIMENTS

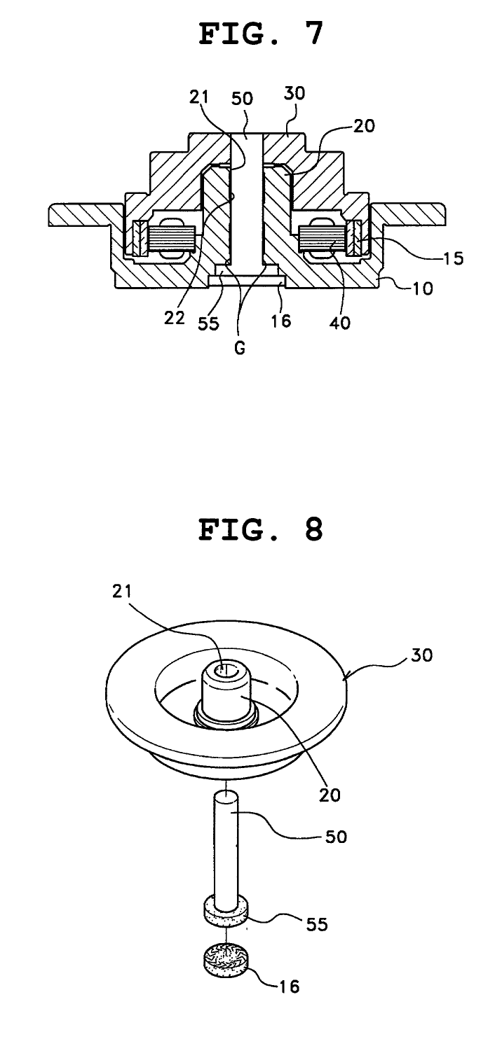

FIG. 7 and FIG. 8 show a shaft-rotating hydrodynamic bearing motor of the invention, which mainly comprises a fixed member for maintaining a fixed state and a rotary member for being rotated through coordination with the fixed member as powered.

The fixed member includes a sleeve 20, a housing 10 and cores 40, the rotary member includes a shaft 50, a hub 30 and magnets 15.

The sleeve 20 has a vertically penetrated axial hole 21 in a central portion for rotatably receiving a shaft 50 as an element of the rotary member.

Such a sleeve 20 has hydrodynamic pressure generating grooves 22 in an inside radius surface of the axial hole 21 so that a hydrodynamic pressure is formed in the radial direction of the shaft 50.

Meanwhile, the sleeve 20 and the shaft 50 are spaced with a certain distance to form oil gaps G in which oil is filled to restrict a mutual abrasion between the sleeve 20 and the shaft 50.

Such oil generates a certain oil pressure while flowing in the rotating direction of the shaft 50 as the shaft 50 is rotated so that the shaft 50 has a nature of moving into the radial direction of the axis and the axial direction under the influence of the oil pressure.

Therefore, previously the dynamic pressure generating grooves have been provided in at least one of an outside radius surface of the shaft 50 and the inside radius surface of the sleeve 20 opposed thereto to generate a strong hydrodynamic pressure in the oil gaps in the radial direction of the axis, which causes the oil gaps between the sleeve 20 and the shaft 50 to be uniformly maintained.

While such dynamic pressure generating grooves 22 formed as means for generating the hydrodynamic pressure in the radial direction of the axis have been generally formed in the outer peripheral surface of the shaft 50, if the dynamic pressure generating grooves are formed in the shaft 50 as one of the rotary member, can abrasion increases between the shaft 50 and the oil to act as a rotative load. Therefore, at present, the dynamic pressure generating grooves 22 are generally formed in the inside radius surface of the sleeve 20 as a non-driving member to generate the hydrodynamic pressure in the radial direction of the axis.

Meanwhile, the outside radius portion of the sleeve 20 has cores 40 fixedly mounted in the outer peripheral end thereof. The cores 40 are wound with coils which are applied with power, and are arranged as opposite to magnets 15 attached in the inner peripheral surface of the hub 30 which will be described later to generate a ceratin amount of electromagnetic force due to an interaction.

Also, the sleeve 20 has a flat cover plate 16 attached to the lower end by an adhesive, etc. to block the lower end of the vertically penetrated axial hole 21 from the outside. The cover plate 16 is rotatably contacted at the upper side with the shaft 50 having a thrust 55.

Here, the thrust 55 is provided in the lower end of the shaft 50 in the shaft-rotating motor as means for generating the hydrodynamic pressure in the axial direction as well as the hydrodynamic pressure in the radial direction of the axis generated by the dynamic pressure generating grooves 22 formed in the sleeve 20.

Also, the shaft 50 has the cap-shaped hub 30 coupled to the upper end. The cap-shaped hub 30 is opened downward and attached with the magnets 15 in the inner peripheral surface, which are arranged as opposit to the outside radius surface of the core 40.

When power is externally applied to the shaft-rotating hydrodynamic bearing motor configured like this, the shaft 50 and the hub 30 are rotationally driven by the electromagnetic force generated due to the interaction of the cores 40 and the magnets 15.

While such a configuration is similar to that of the shaft-rotating hydrodynamic pressure bearing motor in the prior art, the invention has the most prominent features in that the thrust 55 is integrally provided to the shaft 50 while the sleeve 20 and the housing 10 are formed in one-piece.

In other words, the housing 10 has the sleeve 20 extruded upward in a central portion thereof which is integrally formed via a turning, etc., and the sleeve 20 has the axial hole vertically formed in the center as described above.

Such a housing 10 has an outer peripheral edge which is extended upward and has an inner peripheral edge for receiving the lower end of the hub 30 in part. The axial hole 21 of the sleeve 20 extended upward in the central portion rotatably receives the shaft 50 in the vertical direction which is so coupled to the hub 30 that can be integrally rotated with the hub 30.

Meanwhile, the shaft 50 is vertically inserted into the axial hole of the sleeve 20 integrally formed with the housing 10, and is integrally provided at the lower end with the thrust 55 made of a circular flat member. The shaft 50 and the thrust 55 are rotatably contacted with the cover plate 16 at the upper side.

Such a thrust 55 prevents the shaft 50 from rising upward as rotates, and causes the hydrodynamic pressures to be generated in the axial direction between the upper surface of the thrust 55 and the stepped surface of the sleeve 20 and between the lower surface of the thrust 55 and the upper surface of the cover plate 16 for shielding the lower end of the axial hole 21 from the outside.

Here, it is preferable to form dynamic pressure generating grooves (not shown), as in the inside radius surface of the sleeve 20, in the horizontal inside radius surface stepped between the upper axial hole 21 of the sleeve 20 opposed to the upper surface of the thrust 55 and the lower axial hole 21 having the inside radius larger than the upper axial hole, and also in the upper surface of the cover plate 16 coupled at the lower end of the sleeve 20 also to shield the axial hole 21 from the outside.

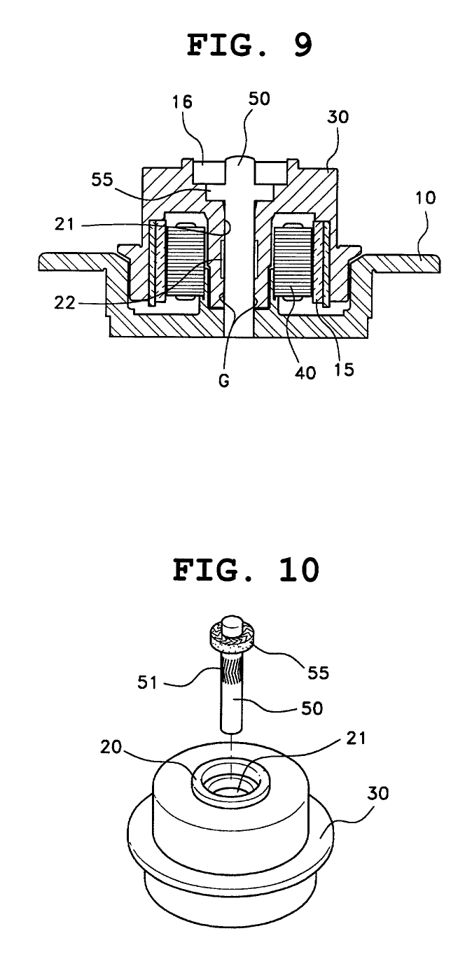

Meanwhile, the invention can be applied to a shaft-fixed hydrodynamic bearing motor as shown in FIG. 9 and FIG. 10.

Referring to FIG. 9 and FIG. 10, the shaft-fixed hydrodynamic bearing motor can be executed in such a configuration also that a thrust 55 is integrally formed to a shaft 50 while a sleeve 20 and a hub 30 are integrally formed as a rotary member.

In other words, the shaft-fixed hydrodynamic bearing motor mainly comprises a fixed member including a housing 10, cores 40 and a shaft 50, and a rotary member including a sleeve 20, a hub 30 and magnets 15.

Such a shaft-fixed hydrodynamic bearing motor has a configuration that the lower end of the shaft 50 is fixed to the housing 10 and the hub 30 integrated with the sleeve 20, rotates around the shaft 50 and oil gaps G are formed between an inside radius portion of the sleeve 20 and an outside radius portion of the shaft 50 for filling oil.

The inside radius portion of the sleeve 20 has the inside radius larger in the upper part than in the lower part, the shaft 50 has the thrust 55 made of a circular flat member at the upper end, and the sleeve 20 formed with an axial hole 21 for receiving the shaft 50 has the cover plate 16 attached thereto by an adhesive, etc. to block the upper end of the vertically penetrated axial hole 21 from the outside.

Here, the thrust 55 performs the same function as the thrust 55 of the aforementioned shaft-rotating motor and thus the additional description thereof will be omitted.

Such a configuration is similar to that of the shaft-fixed hydrodynamic bearing motor except that the thrust 55 is integrally formed to the shaft 50 while the sleeve 20 and the hub 30 are integrally formed in one-piece.

In other words, the hub 30 has the sleeve 20 which is integrally formed in the central portion as extended downward into a tubular shape, and the sleeve 20 has the axial hole 21 which is vertically penetrated in the center as in the prior art.

The hub 30 has the magnets 15 in the inside radius surface of the downwardly extended end, and the magnets 15 generate an electromagnetic force due to an interaction with the cores 40 coupled to the outer peripheral surface of the protrusion formed in the housing 10 to rotate the hub 30 about the shaft 50.

Meanwhile, the shaft 50 is vertically inserted into the axial hole 21 of the sleeve 20 integrally formed to the hub 30, and is integrally provided at the upper end with the thrust 55 made of a circular flat member.

The thrust 55 like this prevents the shaft 50 from moving downward as rotates, and causes the hydrodynamic pressure to be generated in the axial direction between the upper surface of the thrust 55 and the lower surface of the cover plate 16 which shields the axial hole upper end of the sleeve 20 and between the lower surface of the thrust 55 and the stepped surface of the sleeve 20.

Here, it is preferable to form dynamic pressure generating grooves (not shown), as in the inside radius surface of the sleeve 20, in the horizontal inside radius surface stepped between the lower axial hole 21 of the sleeve 20 opposed to the lower surface of the thrust 55 and the upper axial hole 21 having the inside radius larger than the lower axial hole, and also in the lower surface of the cover plate 16 coupled at the upper end of the sleeve 20 also to shield the axial hole 21 from the outside.

Meanwhile, in the shaft-rotating and shaft-fixed hydrodynamic bearing motors configured as above, the shaft 50 and the cover plate 16 use a stainless metal as in the prior art while the sleeve is preferably formed of a ceramic-alloyed aluminium having a thermal expansion coefficient which is lower than or similar to that of the shaft 50 and the cover plate 16.

In other words, Mn in the ceramic-alloyed aluminium increases strength, Mg, Si and Cu increase corrosion resistance and toughness.

Therefore, such a ceramic-alloyed aluminium maintains such properties that the corrosion resistance against oil is higher compared to a general aluminium and hardness and strength are high as well.

When the sleeve 20 is formed of the ceramic-alloyed aluminium from conventional bronze, the property variation of RPO according to the motor temperature is as the following table:

TABLE 1

| | | RRO (μm) | | Variation |
|---|---|---|---|---|
| Material | No | Room temp. | 60° C. | Rate |
| Bronze | 1 | 13.692 | 16.556 | 20.9 |
| | 2 | 16.110 | 15.011 | −6.8 |
| Ceramic-Alloyed | 3 | 14.761 | 14.991 | 1.6 |
| Aluminium | 4 | 23.865 | 25.548 | 7.0 |

It can be seen that the sleeve motor formed of the ceramic-alloyed aluminium has the RRO variation smaller than that of the conventional sleeve motor formed of bronze.

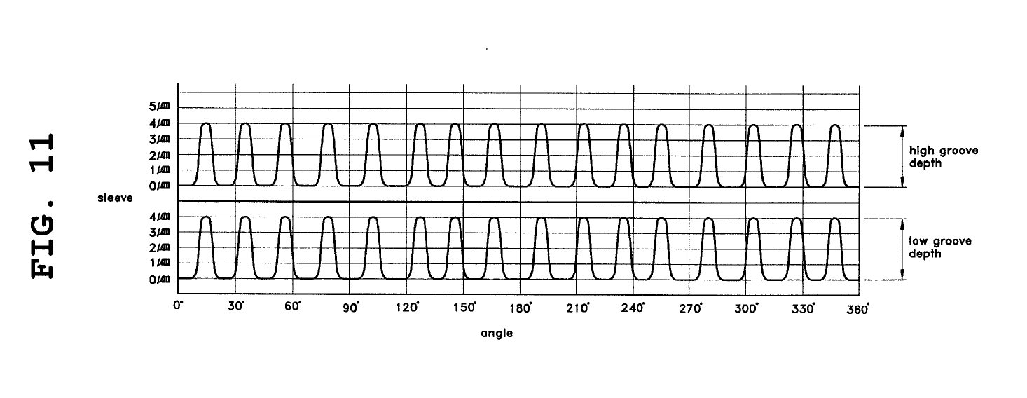

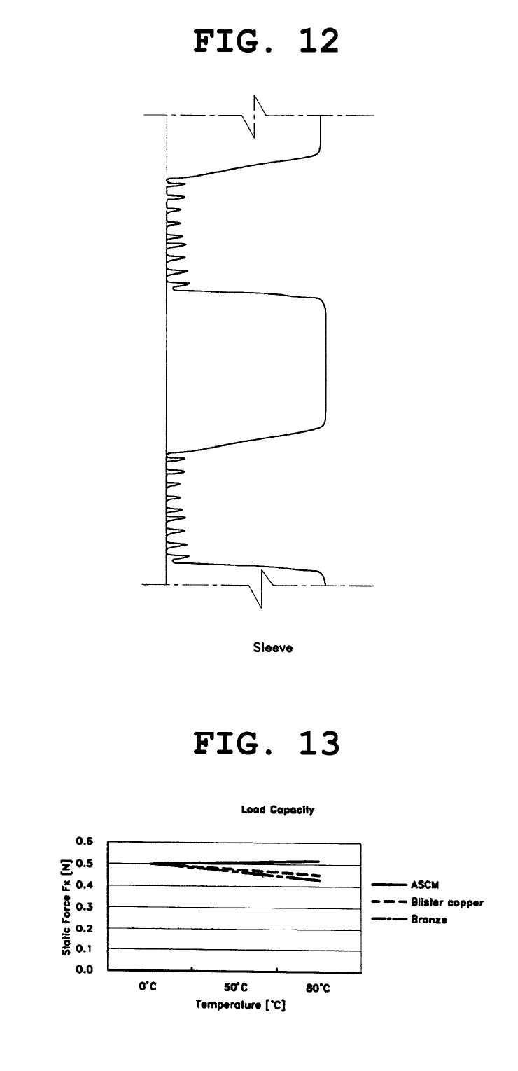

Meanwhile, FIG. 11 and FIG. 12 are graphs for showing a roundness and a straightness of the hydrodynamic bearing motor shown in FIG. 7.

First, referring to the roundness of the sleeve 20 shown in FIG. 11, it can be seen that the present invention can preclude an assembly process such as the conventional interference fitting in designing the dynamic pressure generating grooves 220 with a depth of 4 μm so that the dynamic pressure generating grooves 22 have the shape which is generally uniform and constant in depth.

Also, considering the straightness of the sleeve 20 shown in FIG. 12, it can be seen that there is no difference between the inside radius and the outside radius since the assembly process of the conventional interference fitting is precluded as described above.

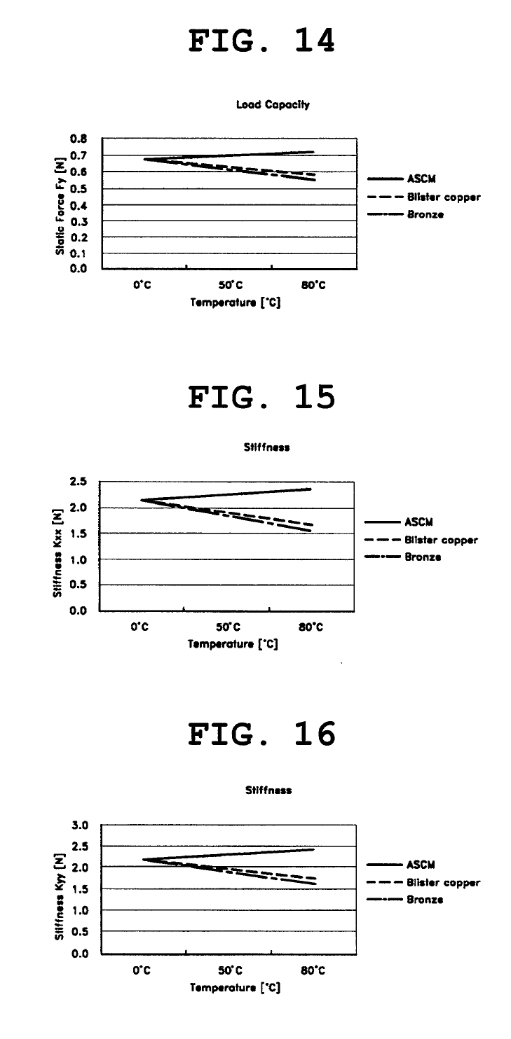

FIG. 13 and FIG. 14 are graphs for comparing the motor in which the integral sleeve 20 is formed of the ceramic-alloyed aluminium (ASCM) with the motor in which the conventional sleeve 20 formed of blister copper or bronze is forced into the housing 10 or the hub 30 in load capacity.

Here, load capacity means magnitude of an external load generated from the bearing which can be supported by the dynamic pressure. If a load capacity of the bearing is smaller than an actual load, dynamic pressure is not generated in a sufficient amount, which becomes a direct reason of lowering performance of the bearing.

In other words, FIG. 13 shows a load capacity in the X-axis direction and FIG. 14 shows a load capacity in the Y-axis direction, in which the sleeve 20 formed of the inventive ceramic-alloyed aluminium shows stable load features even in rising temperatures as shown in the drawings while the sleeve 20 formed of blister copper or bronze shows the features of becoming unstable in proportion to the temperature growth.

FIG. 15 and FIG. 16 are graphs for showing a result of comparing the hydrodynamic bearing motor of the invention with that of the prior art in stiffness, in which FIG. 15 shows a stiffness in the X-axis direction and FIG. 16 shows a stiffness in the Y-axis direction.

Here, stiffness is a main factor for influencing the natural frequency of a motor, and is generally referred to as the ratio of a force applied to the axis to a displacement of the axis.

It can be seen that the inventive motor integrally employing the sleeve 20 formed of the ceramic-alloyed aluminium(ASCM) is employed has a stiffness increasing in proportion to the temperature growth, but the conventional motor in which the sleeve 20 formed of blister copper or bronze has a stiffness decreasing in a relatively large amount.

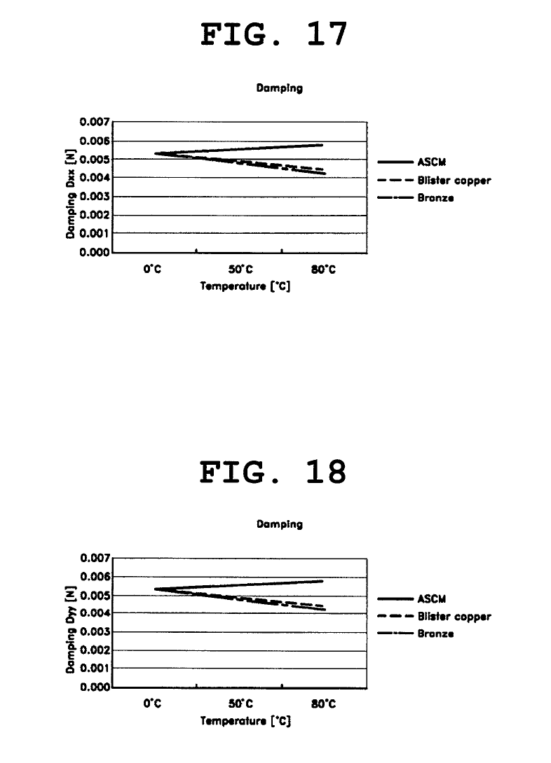

FIG. 17 and FIG. 18 are graphs for showing a result of comparing the hydrodynamic bearing motor of the invention with that of the prior art in damping, in which FIG. 17 shows a damping in the X-axis direction and FIG. 18 shows a damping in the Y-axis direction.

Here, damping attenuates an external force or impact and is related with an impact resistance of the bearing.

As can be seen in the drawings, the inventive motor integrally employing the sleeve 20 formed of the ceramic alloyed aluminium (ASCM) shows a damping force increasing or maintaining stable according to the temperature growth, but the conventional motor assembling the sleeve 20 formed of blister copper or bronze shows a damping force decreasing in a large amount.

According to the invention as described hereinbefore, the thrust 55 is integrally formed with the shaft 50 while forming the sleeve 20 and the housing 10 in one-piece in the shaft-rotating motor and the thrust 55 is integrally formed with the shaft 50 while forming the sleeve 20 and the hub 30 in one-piece in the shaft-fixed motor to enhance a squareness among each part so that the motor can be manufactured easily and the abrasion resistance of the motor can be enhanced as the structural stiffness increases.

Also as described hereinbefore, when the sleeve 20 is formed of the ceramic-alloyed aluminium having the thermal expansion coefficient lower than or similar to that of the shaft 50 or the cover plate 16, the oil gaps G between the sleeve 20 and the shaft 50 can be maintained from being spreaded any more at least in the initial operation in driving the motor at the high speed and temperature so that the property variation in a high temperature is decreased, and in particular, the NRRO and RRO features in the motor can be enhanced.

In particular, the shaft-rotating motor has the sleeve integrally provided to the housing and the shaft-fixed motor has the sleeve integrally provided to the hub so that the squareness is enhanced while the structural stiffness and endurance are increased. Accordingly, there are advantages that the RRO of the motor can be decreased and a noise due to the structural vibration can be smoothed.

Also, the thrust is integrally provided with the shaft to simplify the assembly process and enhance the coaxiality in a great amount so that the NRRO and RRO features for influencing the vibration and noise of the motor can be improved.

Therefore, the invention can enhance the assembly workability, processability and productivity and improve the NRRO and RRO features of the motor due to the structural stiffness and endurance so that reliability on extension of life time and performance can be enhanced as a very useful effect.

What is claimed is:

1. A hydrodynamic bearing motor comprising:
a housing integrated with a sleeve which has a vertically penetrated axial hole and is extended upward in a tubular shape in a central portion of said housing;
cores coupled to an outer peripheral surface of said sleeve;
a shaft for being rotatably inserted into said axial hole of said sleeve and having a flat thrust integrally formed in an lower end thereof;
a hub integrally coupled to an upper end of said shaft and having a downwardly extended end wherein a magnet having at least two poles is attached in an inner peripheral surface of said downwardly extended end thereof for interacting with said cores to generate an electromagnetic force; and
a cover plate for blocking the lower end of said axial hole of the sleeve wherein said shaft is inserted.

2. A hydrodynamic bearing motor according to claim 1, wherein said sleeve is formed of a ceramic-alloyed aluminium.

3. A hydrodynamic bearing motor comprising:
a housing having an upwardly extended outer peripheral edge and an axial hole vertically penetrated in a central portion;
a hub having a integral sleeve which has a vertically penetrated axial hole and is extended downward in a tubular shape in a central portion of said hub, and a downwardly extended end wherein a magnet having at least two poles is attached in an inner peripheral surface of said downwardly extended end thereof;
cores coupled to an outer peripheral surface of an extended portion extended around said axial hole of the housing for generating an electromagnetic force via an interaction with said opposed magnet to rotate said hub;
a shaft vertically inserted into said axial hole of the sleeve, said shaft having an upper end integrally formed with a flat thrust and a lower end fixedly coupled to said axial hole of the housing, wherein said hub is rotated about said shaft; and
a cover plate for blocking an upper end of said axial hole of the sleeve wherein said shaft is inserted.

4. A hydrodynamic bearing motor according to claim 3, wherein said sleeve is formed of a ceramic-alloyed aluminium.
